(19) United States
(12) Patent Application Publication
(10) Pub. No.: US 2011/0018350 A1
(43) Pub. Date: Jan. 27, 2011

(54) POWER BACK-UP SYSTEM WITH A DC-DC CONVERTER

(75) Inventors: Warren Harhay, Boulder City, NV (US); Paul Sarkisian, Boulder City, NV (US)

Correspondence Address: KNOBBE MARTENS OLSON & BEAR LLP, 2040 MAIN STREET, FOURTEENTH FLOOR, IRVINE, CA, 92614, US

(73) Assignee: ROCKY RESEARCH, Boulder City, NV (US)

(21) Appl. No.: 12/510,144

(22) Filed: Jul. 27, 2009

(51) Int. Cl. H02J 1/00

(52) U.S. Cl. 307/77

(57) ABSTRACT

An electromechanical system is configured with power storage for power back-up to maintain substantially uninterrupted power in the case of a main power failure. The power back-up system has a DC power source configured to be recharged, and provides power to the components with a DC-DC converter.

### BACKGROUND

Electromechanical systems generally operate according to AC power received from an AC utility power source, such as an AC mains. Accordingly, an electromechanical system is generally shut down if the power source fails. Shutting down some electromechanical systems is particularly undesirable. For example, shutting down some electromechanical systems results in significant economic loss. Some electromechanical systems employ battery backup devices to help reduce or eliminate the loss. However, for electromechanical systems which use high voltages, many batteries are required, resulting in substantially increased weight and cost of the system. This increases the cost and weight of the system. Electromechanical systems include, for example, pumping systems, elevators, conveyor systems, transport systems, and heating, ventilation, air conditioning, and refrigeration (HVAC/R) compressor and/or fan motors, but are not limited thereto.

### SUMMARY OF THE INVENTION

Described herein is an electromechanical system including one or more electromechanical components, a power bus, configured to transmit power to the electromechanical components. The system also includes first and second power sources, where the second power source includes a DC power storage, configured to generate a DC signal, and a DC to DC converter, configured to generate a substantially DC output for the electromechanical system based on the DC signal. The second power source is configured to increase power output to the power bus as a result of a reduction in power output to the power bus from the first power source. The system also includes a power supply configured to generate an output for the electromechanical system according to power received from the power bus.

In some embodiments, a power supply apparatus for an electromechanical system includes a power bus, and a power input configured to receive power from a first power source and to supply power to the power bus. The system also includes a second power source configured to provide power to the power bus. The second power source comprises a DC power storage, configured to generate a DC signal, a DC to AC inverter, configured to generate an AC signal based on the DC signal, and a rectifier, configured to rectify the AC signal to generate a substantially DC output for the system. The second power source is configured to increase power output to the power bus as a result of a reduction in power output to the power bus from the first power source. The apparatus also includes a power supply configured to generate an output according to power received from the power bus.

In some embodiments, a method of providing back-up power to an electromechanical system includes storing power in a DC power storage, configured to generate a DC signal, generating an AC signal based on the DC signal, and rectifying the AC signal to generate a substantially DC output for the system.

### BRIEF DESCRIPTION OF THE DRAWINGS

FIG. 1 is a schematic block diagram illustrating an electrical system according to one embodiment.

FIG. 2 is a block diagram illustrating a DC power source according to one embodiment.

FIG. 3 is a schematic diagram illustrating an embodiment of the DC power source of FIG. 2.

FIG. 4 is a schematic diagram illustrating the AC to DC converter of FIG. 3 according to one embodiment.

FIG. 5 is an embodiment of a power source switching module.

FIG. 6 is a schematic illustration of an embodiment of a power source switching module.

FIG. 7 is a schematic illustration of an embodiment of a programmable power source switching module.

FIG. 8 is a schematic block diagram illustrating a conventional electrical system.

### DETAILED DESCRIPTION

To provide uninterrupted power to an electromechanical system, the power supply system for the electromechanical components may be configured, such that, rather than receiving power directly from an AC utility source, the system components receive power from a back-up power storage device, for example, a DC battery in parallel with power from the AC utility source. In the system, the AC utility source provides power to the power storage device and to the main DC power bus of the system through a rectifier. The DC power bus is used to provide power to power supply components which generate appropriate AC power for the system components, such as a motor or a heater. In such a configuration, should the AC utility source fail, the DC power bus is powered by the power storage device.

In some embodiments, an electromechanical system includes components driven with a variable frequency drive power supply (VFD). The VFD chops the DC voltage from the DC power bus into three outputs 120 degrees out of phase, which the motors driven see as AC. The VFD allows for efficient start up of the motors being driven, as will be discussed in more detail below. The electromechanical system allows for automatic, unattended operation during power disruptions because of a transparent transition from AC mains power to back-up power.

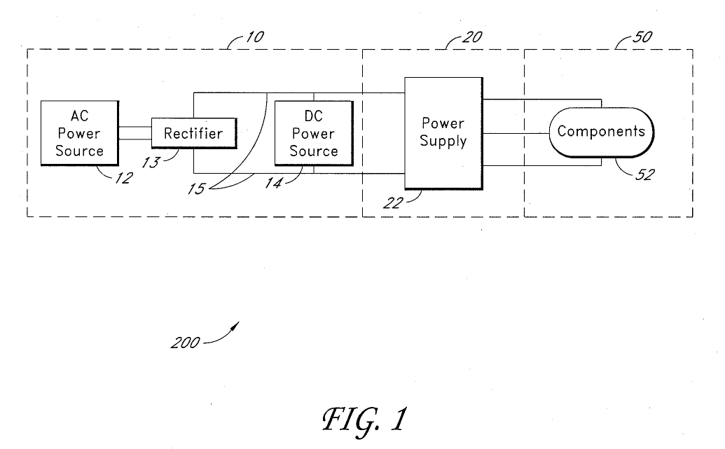

FIG. 1 is a diagram of an electromechanical system incorporating an embodiment of a power supply system. The electromechanical system 200 includes a power source section 10, a power supply section 20, and a component section 50. The power source section 10 includes power sources which provide power to the electromechanical system 200. The power supply section 20 includes power supplies which receive power from the power source section 10 and condition the power for use by the components 52 of the component section 50. The components 52 of the component section 50 perform functions of the electromechanical system, such as driving a fan or a conveyor device.

In the embodiment of FIG. 1, the power source section 10 includes a first power source 12, a rectifier 13, a power bus 15, and a second power source 14. In this embodiment, the first power source 12 is an AC power source and provides power to the rectifier 13, which provides substantially DC power to the power bus 15 and charges the second power source 14. In alternative embodiments, the first power source 12 may be a DC power source, which provides DC power to the power bus 15. Accordingly, in such embodiments, the rectifier 13 is omitted. The second power source 14 is also configured to provide power to the power bus 15.

Power source 12 may be any type of power source. In the embodiment of FIG. 1, power source 12 is an AC power source. Power source 12, for example, may be an AC mains, such as that provided by the local power company. Power source 12 may have, for example, one or three phases. In some embodiments, power source 12 is a three-phase, about 240V, AC source. Another power source, such as a solar or a wind power generator may be additionally or alternatively used.

Rectifier 13 is configured to receive AC power from the first power supply 13, to rectify the power signal to a substantially DC level, and to provide the DC level to the power bus 15 appropriate for the system.

Second power source 14 may be a secondary or back-up power source, for example, a battery or a battery pack, configured to be charged to a level appropriate for the system. Other types of energy storage devices may also be used. The second power source 14 is connected to the power bus 15, and is configured to be charged by the power bus 15 when the first power source 12 is functioning and the second power source 14 is not fully charged. The second power source 14 is further configured to provide power to the power bus 15 when the power from the rectifier 13 or the first power source 12 is insufficient for the load on the power bus 15.

To limit the amount of charging current flowing to the second power source 14, a current limiting circuit (not shown) may be placed between the power bus 15 and the second power source 14. Such a current limiting circuit limits the current charging the second power source 14 according to the limitation and specification of the second power source 14 so that the second power source 14 is not damaged while being charged.

For example, an electromechanical system may be powered by being connected to the power source section 10. The first power source 12 provides power to the DC power bus 15 which is used to operate the electromechanical system. The second power source 14 stores power from the first power source 12 for use in the case of a failure of the first power source 12. Accordingly, the DC power bus 15 is used to provide power to the electromechanical system, and to charge and float the second power source 14.

The second power source 14 is configured to increase power output to the power bus 15 as a result of a reduction in power output to the power bus 15 from the first power source 12. For example, if the first power source 12 reduces its power output, such that it provides some, but less than sufficient power to the power bus 15 for the electromechanical system, the second power source 14 provides the additional supplemental power to the power bus 15 needed to operate the system. Accordingly, the first and second power sources 12 and 14 cooperatively provide the power to the power bus 15 required by the system. The second power source 14 may also be capable of providing sufficient power to the system even if the first power source 12 completely fails and provides no power to the power bus 15. In some embodiments, the total power cooperatively provided to the system by the combination of the first and second power sources 12 and 14 remains uninterrupted or substantially uninterrupted as the amount of power provided by each of the first and second power sources 12 and 14 changes.

The power supply section 20 includes power supplies which receive power from the power source section 10 and condition the power for use by the components 52 of the component section 50. In the embodiment of FIG. 1, there is one power supply 22. In other embodiments, more power supplies are used. Each of the power supplies of the power supply section 20 are used to supply power to one or more of a plurality of components 52 of the component section 50. In the embodiment shown, the power supply 22 is connected to the power bus 15.

In this embodiment, power supply 22 is configured to supply power to the components 52 of the component section 20. Although shown separately, rectifier 13 may be integrated with power supply 22.

In some embodiments, power supply 22 comprises an inverter. In some embodiments, power supply 22 comprises a variable frequency drive power supply (VFD). In some embodiments, the VFD comprises the power supply 22 and the rectifier 13. In embodiments where multiple power supplies are used, one or more of the supplies may comprise an inverter and one or more of the supplies may comprise a VFD. A VFD may be used because of increased power efficiency achieved through controlled start up of the compressor motor 52. When a constant frequency and voltage power supply, such as an AC mains power supply, is used, inrush current to start a motor may be six to ten times the running current. Because of system inertia, the compressor motor is not powerful enough to instantaneously drive the load at full speed in response to the high frequency and high speed signal of the power supply signal needed at full-speed operation. The result is that the motor goes through a start-up phase where the motor slowly and inefficiently transitions from a stopped state to full speed. During start up, some motors draw at least 300% of their rated current while producing less than 50% of their rated torque. As the load of the motor accelerates, the available torque drops and then rises to a peak while the current remains very high until the motor approaches full speed. The high current wastes power and degrades the motor. As a result, overall efficiency, effectiveness, and lifetime of the motor are reduced.

When a VFD is used to start a motor, a low frequency, low voltage power signal is initially applied to the motor. The frequency may be about 2 Hz or less. Starting at such a low frequency allows the load to be driven within the capability of the motor, and avoids the high inrush current that occurs at start up with the constant frequency and voltage power supply. The VFD is used to increase the frequency and voltage with a programmable time profile which keeps the acceleration of the load within the capability of the motor. As a result, the load is accelerated without drawing excessive current. This starting method allows a motor to develop about 150% of its rated torque while drawing only 50% of its rated current. As a result, the VFD allows for reduced motor starting current from either the AC power source 12 or the DC power source 14, reducing operational costs, placing less mechanical stress on a motor of the components 52, and increasing service life. The VFD also allows for programmable control of acceleration and deceleration of the load.

A VFD of power supply 22 may produce a single-phase or a three-phase output, which powers a motor of the components 52. A three-phase motor of the components 52 has rotational symmetry of rotating magnetic fields such that an armature is magnetized and torque is developed. By controlling the voltage and frequency of the three-phase power signal, the speed of the motor is controlled whereby the proper amount of energy enters the motor windings so as to operate the motor efficiently while meeting the demand of the accelerating load. Electrical motive is generated by switching electronic components to derive a voltage waveform which, when averaged by the inductance of the motor, becomes the sinusoidal current waveform for the motor to operate with the desired speed and torque. The controlled start up of a motor described above allows for high power efficiency and long life of the motor.

In some embodiments, power supply 22 comprises a switching type inverter which generates a pseudo-sine wave by chopping the DC input voltage into pulses. The pulses are used as square waves for a step-down transformer which is followed by a wave shaping circuit, which uses a filter network to integrate and shape the pulsating secondary voltage into the pseudo-sine wave.

In some embodiments, one or more of the components 52 of the component section 50 are DC powered components and receive power directly from the power bus 15.

In some embodiments, the power supply 22 uses a power bus voltage which can be in the range of about 250V to 320V. In such embodiments, the DC power source 14 can be a pack of multiple 12V batteries. However, in some embodiments, it is advantageous to use fewer batteries. In such embodiments, the lower voltage of the fewer batteries is converted to a higher voltage through a DC to DC converter. By functioning at a much lower battery supply voltage, the system allows for vehicular applications and stationary applications which do not have convenient access to poly-phase AC power. In these applications, a vehicle battery could become the primary source of back-up energy. Such a system provides the needed high voltage supply from a much lower voltage source allowing for less storage battery weight and space.

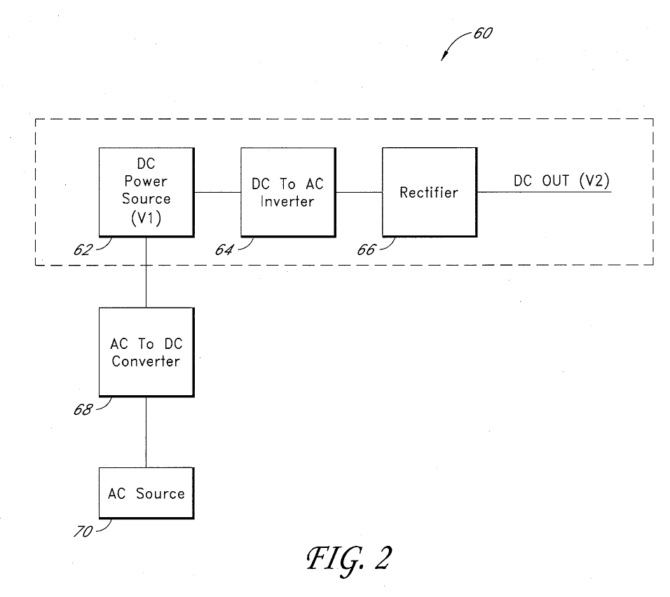

FIG. 2 shows an embodiment of a DC power source 60 for use as the DC power source 14 of FIG. 1. The DC power source 60 of FIG. 1 performs a DC-DC conversion from a first voltage V1 of a DC power source 62 to a DC out voltage V2. This is particularly advantageous where applications prefer to use few storage batteries, but use a high voltage for the power bus.

In the embodiment of FIG. 2, a DC power source 62 is connected to a DC to AC inverter 64. The DC power source 62 has a first voltage V1, which drives the inverter 64. In response to the first voltage V1, the inverter 64 outputs an AC signal, which is supplied to the rectifier 66. The rectifier 66 operates as an AC to DC converter and provides the DC out voltage V2 having a DC voltage level appropriate for the system.

The DC power source 62 can be recharged by AC to DC converter 68. AC to DC converter 68 receives an AC signal from an AC source 70, and generates a DC voltage, which is used to charge the DC power source 62. In some embodiments, the AC source is the AC power source 12 of the system of FIG. 1. In some embodiments, the AC source is the output of the power supply 22 of FIG. 1. In some embodiments, the DC power source 62 is recharged by the engine of a vehicle.

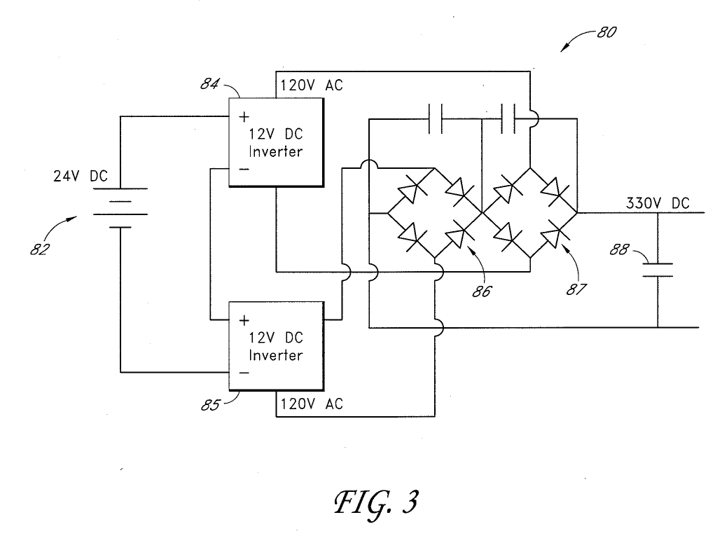

FIG. 3 is a schematic diagram showing an embodiment of the DC power source 62, the inverter 64, and the rectifier 66 of the DC power source 60 of FIG. 2. DC power source 80 includes a battery 82, two 12V DC to 120V AC inverters 84 and 85, rectifiers 86 and 87, and filter 88. DC power source 80 is configured to generate a 330V DC signal based on a 24V DC signal.

The battery 82 provides the 24V DC signal, and is configured to be recharged. In some embodiments, the battery 82 comprises two 12-volt batteries.

The two inverters 84 and 85 are each configured to receive a 12V DC input and output a 120V rms AC signal. In some embodiments, the DC power source 60, the inverters 84 and 85 are serially connected across the 24-volt battery 82. Accordingly, the inverters 84 and 85 each receive a 12V input. In response to the 12V input, the inverters 84 and 85 each produce an AC signal of about 120V rms.

The 120V rms AC signal of inverter 84 is provided to rectifier 87, and the 120V rms AC signal of inverter 85 is provided to rectifier 86. The rectifiers 86 and 87 rectify the respective AC signals producing substantially DC outputs of about 165V each. The rectifiers 86 and 87 are connected in serial, and therefore collectively produce a substantially DC signal of about 330V. In the embodiment shown in FIG. 3, the rectifiers 86 and 87 are each shown as a four diode bridge rectifier in parallel with a capacitor. Other rectifier configurations may be used.

The filter 88 is connected across the serially connected rectifiers 86 and 87. The filter is configured to improve the quality of the DC output signal by filtering non-DC components of the signal produced by the rectifiers 86 and 87. As shown in FIG. 3, the filter 88 is a single capacitor. In other embodiments other filters may be used.

In some embodiments, the DC power source 62 of FIG. 2 is a 12V DC battery, and the DC to AC inverter 64 comprises two 12V DC to 120V AC inverters connected across the 12V battery. In such embodiments, rectifiers such as rectifiers 86 and 87 may be used to produce two substantially DC signals of about 165V each. As in the embodiment of FIG. 3, the rectifiers may be connected in series to produce a substantially DC 330V signal. Because of the arrangement of the inverters 84 and 85 and the rectifiers 86 and 87, the substantially DC voltage produced is independent of the frequency and phase of each of the AC signals of the inverters 84 and 85.

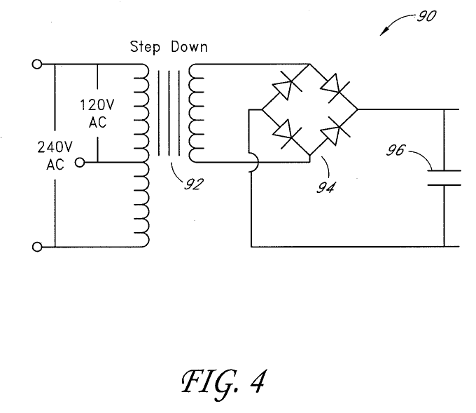

FIG. 4 is a schematic diagram showing an embodiment of an AC to DC converter 90 which can be used as an AC to DC converter 68 for the DC power source 60 of FIG. 2. The converter 90 receives either an about 230V AC signal or an about 120V AC signal and produces an about 30V DC signal to be used for charging the DC power source 62 of the DC power source 60. Converter 90 includes a transformer 92, a rectifier 94, and a filter 96.

The transformer 92 includes three taps on the input side. In order for the converter 90 to produce the desired about 30V DC output signal, an about 120V AC signal is driven across the uppermost and the middle tap of the transformer 92 as shown in FIG. 4. In order to accomplish this, either an about 120V AC signal is driven directly across the uppermost and the middle tap of the transformer 92, or an about 240V AC signal is driven across the outer taps, as shown. The transformer steps down the input voltage to produce an output for the rectifier 94, which in combination with the filter 96, produces a substantially DC signal used to charge the DC power source 62 of FIG. 2. In the embodiment shown in FIG. 4, the rectifier 94 is shown as a four diode bridge rectifier. Other rectifier configurations may be used. As shown in FIG. 4, the filter 96 is a single capacitor. In other embodiments other filters may be used.

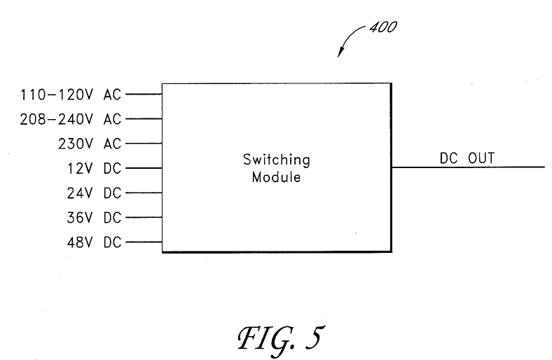

In some embodiments, the power source section 10 of FIG. 1 comprises a power source switching module, such as that shown in FIG. 5. The power source switching module 400 receives multiple power source inputs and either automatically or according to programmed instructions, selects a power source for providing power to the DC output.

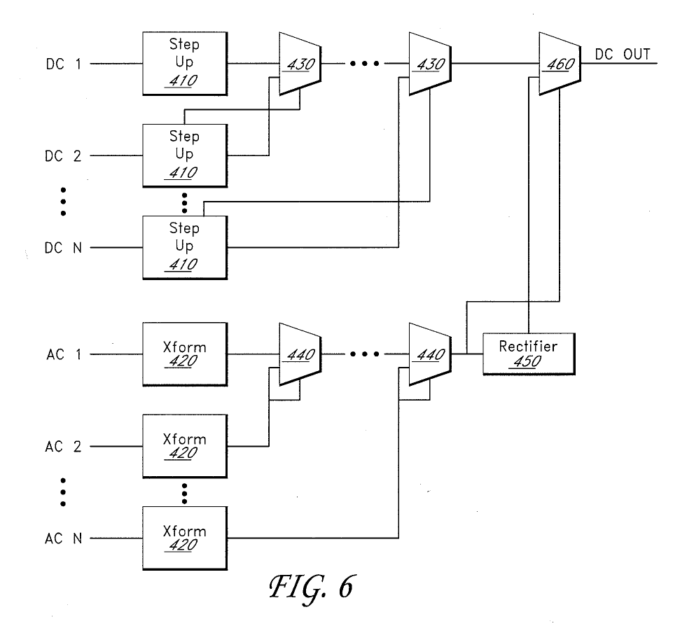

FIG. 6 is a schematic illustration of an embodiment of a power source switching module. The power source switching module of FIG. 6 is automatic. In this embodiment, the power source switching module has a step up module 410 for each DC input, a series of select modules 430 for selecting one of the DC inputs, a transformer 420 for each AC input, a series of select modules 440 for selecting one of the AC inputs, a rectifier 450, and a select module 460 for selecting either the selected stepped up DC input or the rectified selected transformed AC input.

In this embodiment, each of the step up modules 410 receive its DC input and steps up that received DC input to the desired DC output, for example 330V DC. In addition, each of the step up modules 410 may provide a control signal for a select module. Each of the step up modules 410 may have similar components and similar functionality as the DC power source 80 of FIG. 3.

In this embodiment, each of the select modules 430 receives a DC signal from each of two step up modules 410, and a control signal from one step up module 410. The select modules 430 are configured to select one of the two DC signals according to the control signal. In some embodiments, the select modules 430 comprise relays, which, upon receiving a control signal indicating that one of the received two DC input signals is active, selects the stepped up DC voltage of that DC input signal. For example, if there is a DC input signal at both the DC1 and DC2 inputs, the step up module 410 of the DC1 input generates a stepped up voltage at one of the two inputs to a select module 430, as shown. In addition, the step up module 410 of the DC2 input generates a stepped up voltage at the other of the two inputs to the select module 430, and generates a control signal for the select module 430, indicating that the DC2 input is active. In response to the control signal, the select module selects the stepped up DC2 voltage.

Accordingly, in this embodiment, the select modules 430 collectively select the stepped up DC voltage corresponding to the active DC input of the highest priority, where the priority of the DC inputs is determined by which select module 430 each stepped up DC voltage is connected to.

In this embodiment, each of the select modules 440 receives an AC signals from each of two transformers 420, and a control signal from one transformer 420. In this embodiment, the control signal is the AC signal from the one transformer 420. The select modules 440 are configured to select one of the two AC signals according to the control signal. In some embodiments, the select modules 440 comprise relays, which, upon receiving a control signal indicating that one of the received two AC input signals is active, selects the transformed signal of that AC input signal. For example, if there is an AC input signal at both the AC1 and AC2 inputs, the transformer 420 of the AC1 input generates an AC voltage at one of the two inputs to a select module 440, as shown. In addition, the transformer 420 of the AC2 input generates a transformed AC voltage at the other of the two inputs to the select module 440, and generates a control signal for the select module 440, indicating that the AC2 input is active. In response to the control signal, the select module selects the transformed AC2 voltage.

Accordingly, in this embodiment, the select modules 440 collectively select the transformed AC voltage corresponding to the active AC input of the highest priority, where the priority of the DC inputs is determined by which select module 440 each transformed AC voltage is connected to.

The rectifier 450 rectifies the selected AC voltage, and provides the rectified AC voltage to the select module 460, which selects the rectified AC voltage as the DC output if any of the AC input signals is active.

In some embodiments, one or more of the DC input voltages is not stepped up. In some embodiments, one or more of the AC input voltages is not transformed. In some embodiments, the priority of the various input voltages is different than that of the embodiment of FIG. 6.

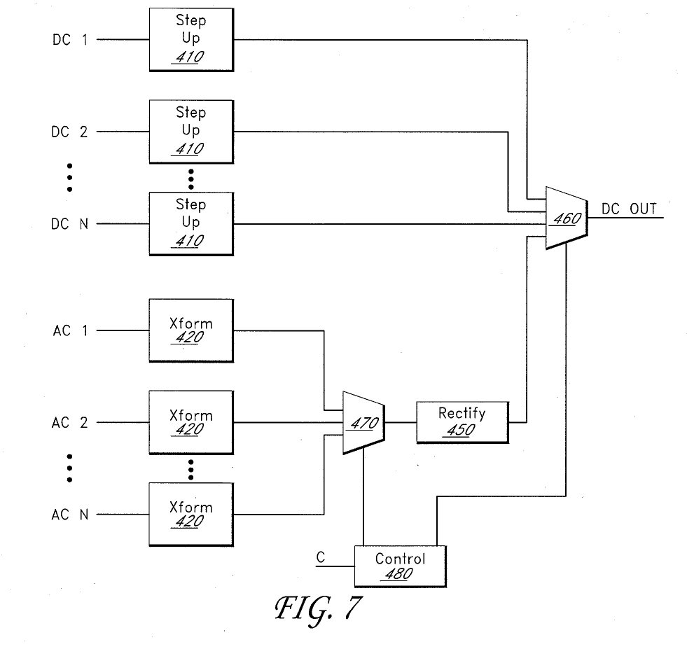

FIG. 7 is a schematic illustration of another embodiment of a power source switching module. The power source switching module of FIG. 7 is programmable. In this embodiment, the power source switching module has a step up module 410 for each DC input. The step up modules 410 of this embodiment may be similar to the step up modules 410 of the embodiment of FIG. 6. In this embodiment, the power switching module has a transformer 420 for each AC input. The transformers 420 of this embodiment may be similar to the transformers 420 of the embodiment of FIG. 6. The power switching module of this embodiment also has a select module 470, rectifier 450, a select module 460 for selecting either one of the stepped up DC input voltages or the rectified selected transformed AC input, and a control module 480, which selects the voltage to be output based on a signal C.

In this embodiment, the output voltage is not determined by selections based on priority according to position. Instead, the control module 480 is configured to select the output voltage according to signal C. In some embodiments, the signal C represents which input voltages are active. In some embodiments, the signal C is input from another circuit.

In some embodiments, one or more of the DC input voltages is not stepped up. In some embodiments, one or more of the AC input voltages is not transformed.

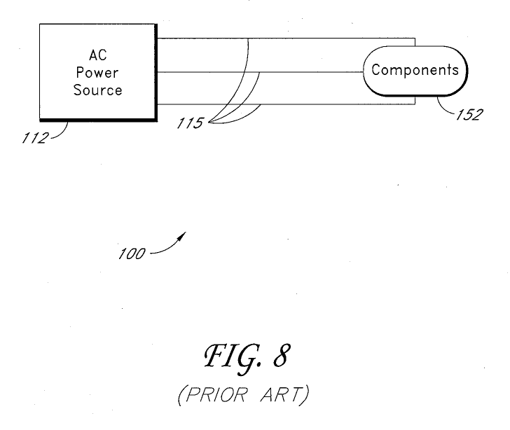

An existing electromechanical system may be converted to function similarly to or identically to system 200. For example, conventional system 100 shown in FIG. 8 may be converted to operate and achieve the advantages previously described. To convert system 100, as shown in FIG. 8, and to operate and achieve the advantages previously described, AC power source 112 and the components 152 are disconnected from power bus 115. Referring also to FIG. 1, AC power source 112 is connected to power a power bus, such as power bus 15 with a rectifier, such as rectifier 13. A DC power storage source, such as DC power source 14 is connected to the power bus. A first power supply, such as power supply 22, is connected to the power bus and to the components 152. Any additional power supplies are connected to power bus 15 and to components to receive power from the additional power supplies. Any control circuitry is connected to a power supply and to any of the components to be controlled by the control circuitry.

While the above detailed description has shown, described, and pointed out novel features as applied to various embodiments, it will be understood that various omissions, substitutions, and changes in the form and details of the devices and processes illustrated may be made by those skilled in the art without departing from the spirit of the invention. For example, inputs, outputs, and signals are given by example only. As will be recognized, the present invention may be embodied within a form that does not provide all of the features and benefits set forth herein, as some features may be used or practiced separately from others.

What is claimed is:

1. An electromechanical system, comprising:
one or more electromechanical components;
a power bus, configured to transmit power to the electromechanical components;
a power input configured to receive power from a first power source and to provide power to the power bus;
a second power source configured to provide power to the power bus, wherein the second power source comprises:
a DC power storage, configured to generate a DC signal; and
a DC to DC converter, configured to generate a substantially DC output to the power bus based on the DC signal,
wherein the second power source is configured to increase power output to the power bus as a result of a reduction in power output to the power bus from the first power source; and
a power supply configured to generate an output for the electromechanical components according to power received from the power bus.

2. The system of claim 1, wherein the DC output has voltage higher than the voltage of the DC signal of the DC power storage.

3. The system of claim 1, wherein the DC power storage comprises a single 12V DC battery.

4. The system of claim 1, wherein the DC power storage comprises two 1 2V DC batteries.

5. The system of claim 1, wherein the DC to DC converter comprises:
a DC to AC inverter configured to generate an AC signal; and
an AC to DC converter, configured to generate the substantially DC output based on the AC signal.

6. The system of claim 1, wherein the DC power source is rechargeable.

7. The system of claim 6, further comprising an AC to DC converter, configured to recharge the DC power source.

8. The system of claim 6, wherein the AC to DC converter comprises a transformer and a rectifier.

9. The system of claim 8, wherein the transformer is configured to receive either of two different AC voltages to generate a DC voltage for recharging the DC power source.

10. The system of claim 8, wherein the transformer is connected to an AC power source of the system.

11. The system of claim 8, wherein the power supply comprises a variable frequency drive power supply (VFD), and the transformer is connected to an output of the VFD.

12. The system of claim 1, wherein the second power source comprises a power source switching module, configured to generate the substantially DC output selectively based on a plurality of inputs.

13. The system of claim 12, wherein the power source switching module is automatic.

14. The system of claim 12, wherein the power source switching module is programmable.

15. The system of claim 12, wherein the power source switching module comprises a step up module for each of one or more DC inputs.

16. A power supply apparatus for an electromechanical system, comprising:
a power bus;
a power input configured to receive power from a first power source and to supply power to the power bus;
a second power source configured to provide power to the power bus, wherein the second power source comprises:
a DC power storage, configured to generate a DC signal;
a DC to AC inverter, configured to generate an AC signal based on the DC signal; and
a rectifier, configured to rectify the AC signal to generate a substantially DC output for the system,
wherein the second power source is configured to increase power output to the power bus as a result of a reduction in power output to the power bus from the first power source; and
a power supply configured to generate an output according to power received from the power bus.

17. The apparatus of claim 16, wherein the DC output has voltage higher than the voltage of the DC signal of the DC power storage.

18. The apparatus of claim 16, wherein the DC to AC inverter comprises two 12V DC to 120V AC inverters.

19. The apparatus of claim 16, wherein the DC power source is rechargeable.

20. The apparatus of claim 19, further comprising an AC to DC converter, configured to recharge the DC power source.

21. The apparatus of claim 20, wherein the AC to DC converter comprises a transformer and a rectifier.

22. The apparatus of claim 21, wherein the transformer is configured to receive either of two different AC voltages to generate a DC voltage for recharging the DC power source.

23. The apparatus of claim 21, wherein the transformer is connected to an AC power source of the system.

24. The apparatus of claim 21, further comprising:
a variable frequency drive power supply (VFD), wherein the transformer is connected to an output of the VFD.

25. The system of claim 16, wherein the second power source comprises a power source switching module, configured to generate the substantially DC output selectively based on a plurality of inputs.

26. The system of claim 25, wherein the power source switching module is automatic.

27. The system of claim 25, wherein the power source switching module is programmable.

28. The system of claim 25, wherein the power source switching module comprises a step up module for each of one or more DC inputs.

29. A method of providing back-up power to an electromechanical system, the method comprising:
storing power in a DC power storage, configured to generate a DC signal;
generating an AC signal based on the DC signal; and
rectifying the AC signal to generate a substantially DC output for the system.

30. The method of claim 29, wherein the DC output has voltage higher than the voltage of the DC signal of the DC power storage.

31. The method of claim 29, further comprising recharging the DC power storage.
